(19) United States
(12) Patent Application Publication
(10) Pub. No.: US 2013/0153193 A1
(43) Pub. Date: Jun. 20, 2013

(54) BIDIRECTIONAL HEAT SINK FOR PACKAGE ELEMENT AND METHOD FOR ASSEMBLING THE SAME

(71) Applicants: Wei-Guo Li, Shanghai (CN); Le-Xing He, Shanghai (CN)

(72) Inventors: Wei-Guo Li, Shanghai (CN); Le-Xing He, Shanghai (CN)

(73) Assignee: Delta Electronics (Shanghai) Co.,Ltd.

(21) Appl. No.: 13/475,171

(22) Filed: May 18, 2012

(30) Foreign Application Priority Data
Jul. 13, 2011 (CN) 201110196188.8

(51) Int. Cl. F28F 7/00; B23P 19/04

(52) U.S. Cl. 165/185; 29/428

(57) ABSTRACT

In a bidirectional heat sink for a package element and a method for assembling the same, the bidirectional heat sink includes a first heat-dissipating plate, a second heat-dissipating plate, and a plurality of heat-dissipating pieces. The first heat-dissipating plate is provided with a groove. Both sides of the groove are formed with two separation walls. The package element is inserted into the groove to contact the two separation walls. The second heat-dissipating plate extends from one end of the first heat-dissipating plate. Each of the heat-dissipating pieces extends from the second heat-dissipating plate in a direction away from the first heat-dissipating plat). By this structure, the contact area of the package element is increased to improve the heat-dissipating efficiency. Further, the assembling process is performed quickly to form a firm structure.

### BACKGROUND

1. Technical Field

The present disclosure relates to a heat sink, and in particular to a bidirectional heat sink for a package element and a method for assembling the same.

2. Description of Prior Art

Integrated Circuit (IC) is widely used in modern electronic product. With the spread of information electronic products, the research and development of IC is progressing to a higher level. For example, in the information electronic products, the degree of integration of the IC elements is increased greatly, so that many tiny function pins are provided therein. The manufacturers of IC elements continuously reduce the area and volume of IC elements, thereby increasing the ratio of performance to price. Since the IC elements have high performance and large power consumption, it is an important issue to solve the assembly and the heat dissipation of the IC elements.

The conventional methods for assembling the IC elements are as follows. As shown in FIG. 1, a metallic clip 1a made by metal sheet formation is used to clamp an IC element 4a, and the metallic clip 1a is fixed by a screw 2a. As shown in FIG. 2, a plastic clip 1b is used to tightly press an IC element 4b on a heat sink 3b, and the plastic clip 1b is fixed by a screw 2b. In these two conventional solutions, the IC element 4a, 4b is fixed to the heat sink 3a, 3b to form an one-piece combination, and then the thus-formed combination is inserted onto a printed wiring board (PWB) 5a, 5b, and fixed thereon by a soldering process.

The above two conventional methods for assembling the IC element 4a, 4b need to use a metallic clip 1a or a plastic clip 1b. Further, the screw 2a, 2b is used to fix the IC element 4a, 4b to the heat sink 3a, 3b to form an one-piece combination. The thus-formed combination is inserted onto the printed wiring board 5a, 5b. However, since the IC element 4a, 4b is a highly-integrated electronic component of a small volume, it has a compact delicate structure and an insufficient strength. As a result, the above two conventional methods for assembling the IC elements have problems as follows:

(1) The IC element may suffer damage due to external forces to deteriorate its quality and lifetime. Further, it is not easy to perform the quality control for the IC elements.

(2) Only one surface of the IC element 4a, 4b is brought into thermal contact with the heat sink 3a, 3b, so that the heat-conducting effect or the heat-dissipating effect for the IC element is insufficient, which also deteriorates the quality and stability of the electronic product having the IC element.

(3) Clips and screws are needed, which increases higher material cost and labor hour for assembly. When a plurality of transistor components and the IC element 4a, 4b are fixed to the heat sink 3a, 3b to form the one-piece combination, it is more difficult to insert the thus-formed combination onto the printed wiring board 5a, 5b because a lot of pins have to be correctly inserted into holes on the printed wiring board 5a, 5b. If one or more pins are not correctly inserted into the holes on the printed wiring board, it may become an unusable component after soldering, which reduces the yield.

### BRIEF SUMMARY

The present disclosure is to provide a bidirectional heat sink for a package element and a method for assembling the same, whereby the surface area for heat dissipation between the heat sink and the package element is increased. Thus, the heat-dissipating efficiency is increased. The assembly is performed quickly to form a firm structure.

The present disclosure is to provide a bidirectional heat sink for a package element, which includes a first heat-dissipating plate, a second heat-dissipating plate, and a plurality of heat-dissipating pieces. The first heat-dissipating plate is provided with a groove. Both sides of the groove are formed with two separation walls. The package element is inserted into the groove to contact the two separation walls. The second heat-dissipating plate extends from one end of the first heat-dissipating plate. Each of the heat-dissipating pieces extends from the second heat-dissipating plate in a direction away from the first heat-dissipating plate.

The present disclosure provides a method for assembling a package element and a bidirectional heat sink, which includes steps of:

a) providing a circuit board and a package element, inserting the package element onto the circuit board;

b) providing a bidirectional heat sink having a groove and two separation walls formed on both sides of the groove;

c) disposing the groove of the bidirectional heat sink onto the package element to form a semi-product; and

d) preparing a heating apparatus, disposing the semi-product after the step c) into the heating apparatus for soldering.

### BRIEF DESCRIPTION OF DRAWING

FIG. 1 is an assembled cross-sectional view showing that a conventional heat sink applied to a package element;

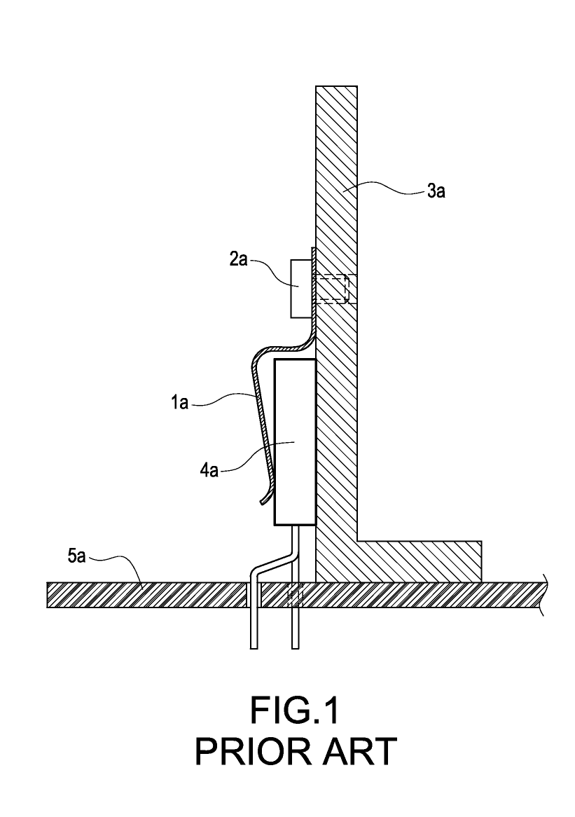

FIG. 2 is an assembled cross-sectional view showing that another conventional heat sink applied to a package element;

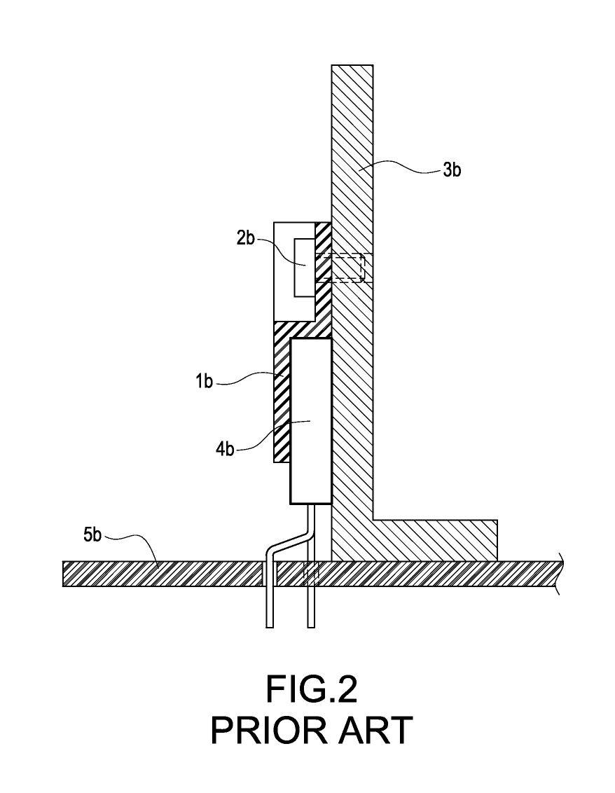

FIG. 3 is an exploded perspective view showing the bidirectional heat sink of the present disclosure and a package element;

FIG. 4 is an assembled view showing the bidirectional heat sink of the present disclosure and a package element;

FIG. 5 is an assembled cross-sectional view showing the bidirectional heat sink of the present disclosure and a package element;

FIG. 6 is an exploded perspective view showing the bidirectional heat sink of another embodiment of the present disclosure and a package element;

FIG. 7 is an assembled perspective view showing the bidirectional heat sink and the package element of FIG. 6;

FIG. 8 is a flow chart showing a method for assembling the bidirectional heat sink and a package element.

### DETAILED DESCRIPTION

The detailed description and technical contents of the present disclosure will become apparent with the following detailed description accompanied with related drawings. It is noteworthy to point out that the drawings is provided for the illustration purpose only, but not intended for limiting the scope of the present disclosure.

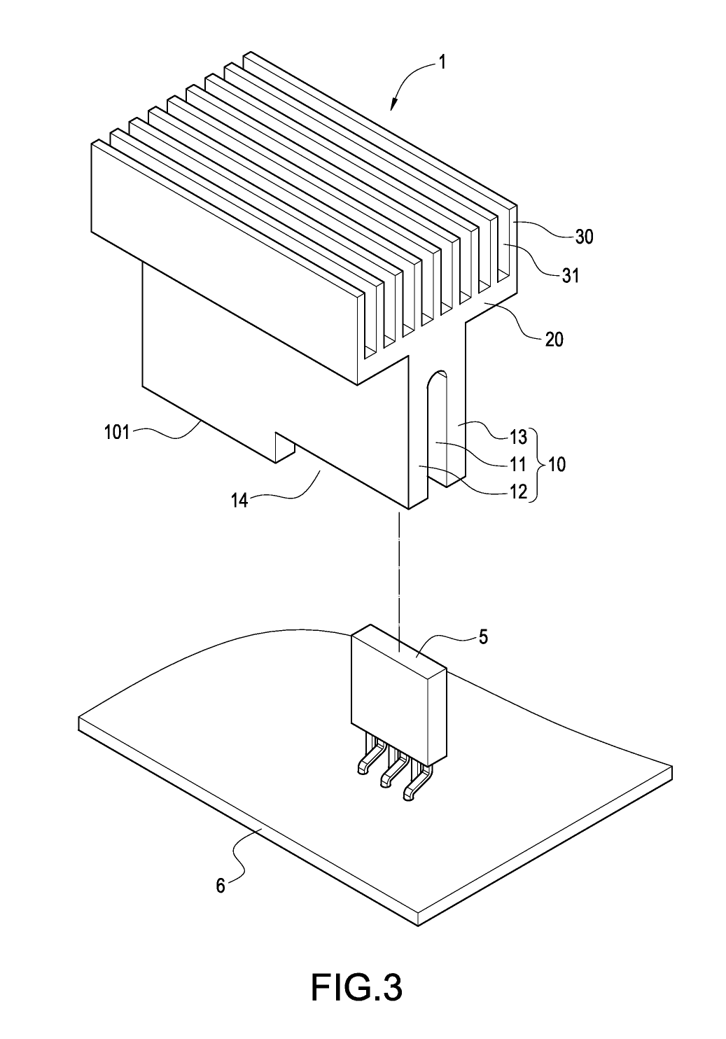

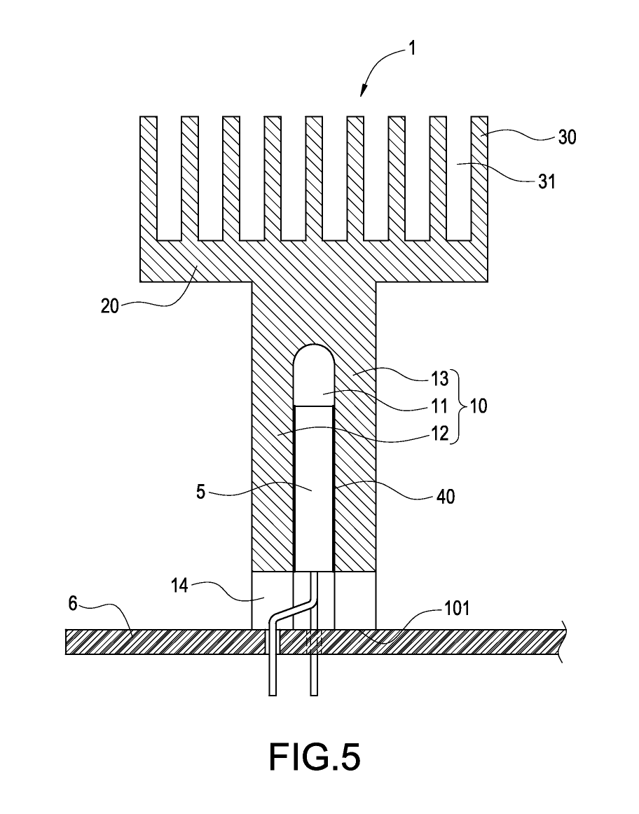

Please refer to FIG. 3 to FIG. 5. The present disclosure relates to a bidirectional heat sink for a package element. The bidirectional heat sink 1 is made of metallic materials such as aluminum, copper or alloy thereof, and it includes a first heat-dissipating plate 10, a second heat-dissipating plate 20 and a plurality of heat-dissipating pieces 30.

In the present embodiment, the first heat-dissipating plate 10 is formed into a longitudinal rectangular body, but it is not limited thereto. The middle portion of the first heat-dissipating plate 10 is provided with a groove 11. Both sides of the groove 11 are formed with two separation walls 12 and 13.

The second heat-dissipating plate 20 extends from the top end of the first heat-dissipating plate 10. The second heat-dissipating plate 20 is formed into a transverse rectangular body. The second heat-dissipating plate 20 is arranged to be perpendicular to the first heat-dissipating plate 10, thereby forming a T-shaped structure. Further, one end of the separation wall 12, 13 in the first heat-dissipating plate 10 is provided with a notch 14 away from the second heat-dissipating plate 20.

Each of the heat-dissipating plates 30 extends from the second heat-dissipating plate 20 in a direction away from the first heat-dissipating plate 10. The heat-dissipating plates 30 are integrally formed with the first heat-dissipating plate 10 and the second heat-dissipating plate 20. The heat-dissipating plates 30 are arranged at intervals and in parallel to each other. A heat-dissipating channel 31 is formed between any two adjacent heat-dissipating pieces 30.

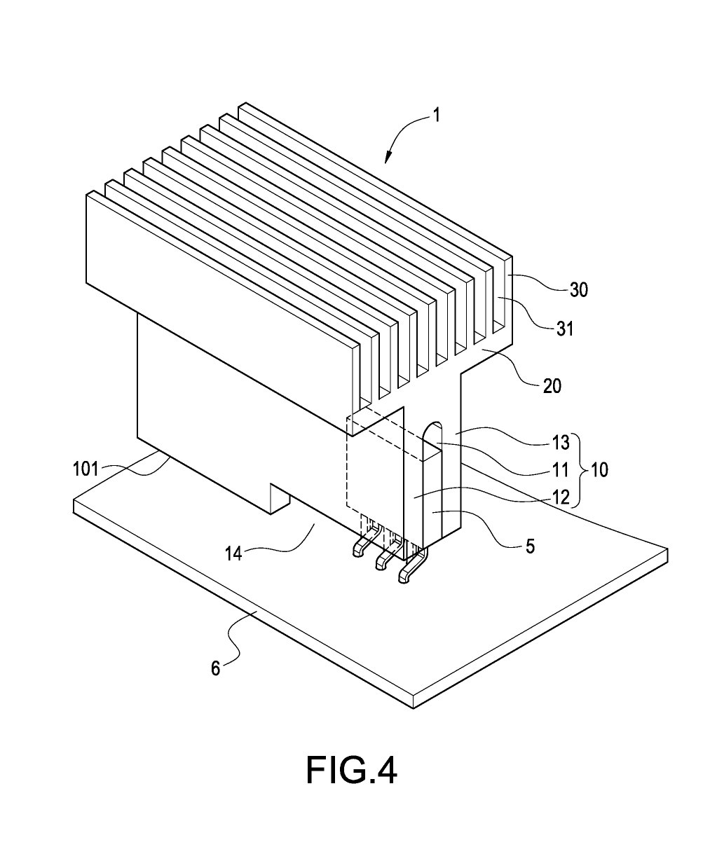

In assembly, as shown in FIG. 4, the groove 11 of the first heat-dissipating plate 10 is directly disposed on a package element 5. The package element 5 is fixed onto a printed circuit board 6. The front and rear surfaces of the package element 5 are brought into direct thermal contact with the inner surfaces of the separation walls 12 and 13. The notch 14 of the first heat-dissipating plate 10 is located to correspond to pins of the package element 5, so that the bottom surface 101 of the first heat-dissipating plate 10 is adhered to the printed circuit board 6 to form a firm structure.

Further, in the bidirectional heat sink 1 of the present disclosure, a heat-conducting medium 40 is filled between the surfaces of the separation wall 12, 13 and the package element 5. The heat-conducting medium 40 is used to fill apertures or slits on the surfaces of the separation walls 12, 13 and the package element 5, so that the separation walls 12, 13 can be tightly adhered to the package element 5 to increase the heat-conducting efficiency.

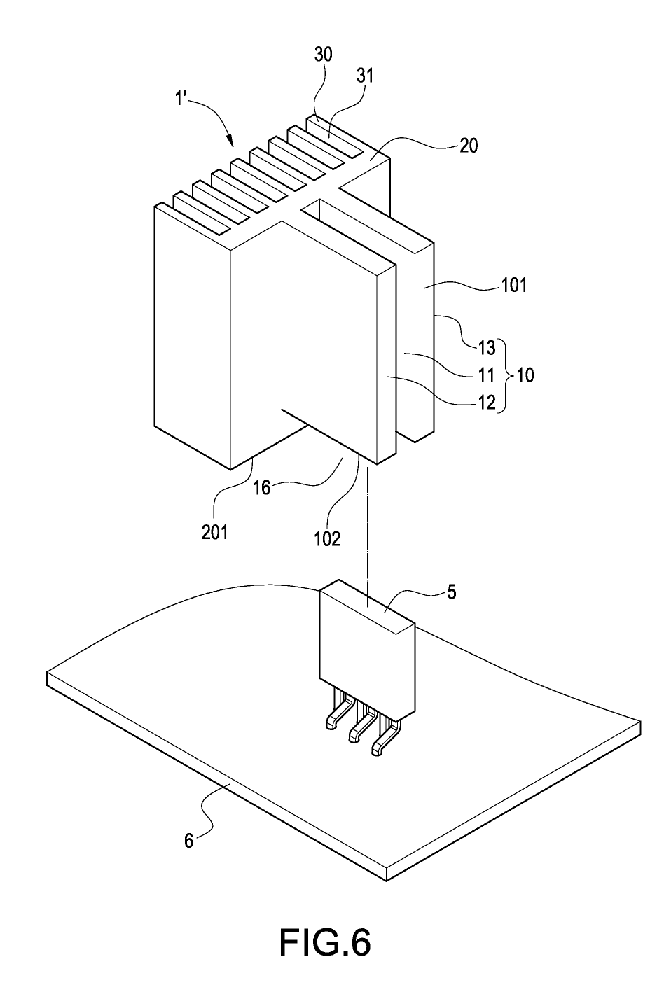

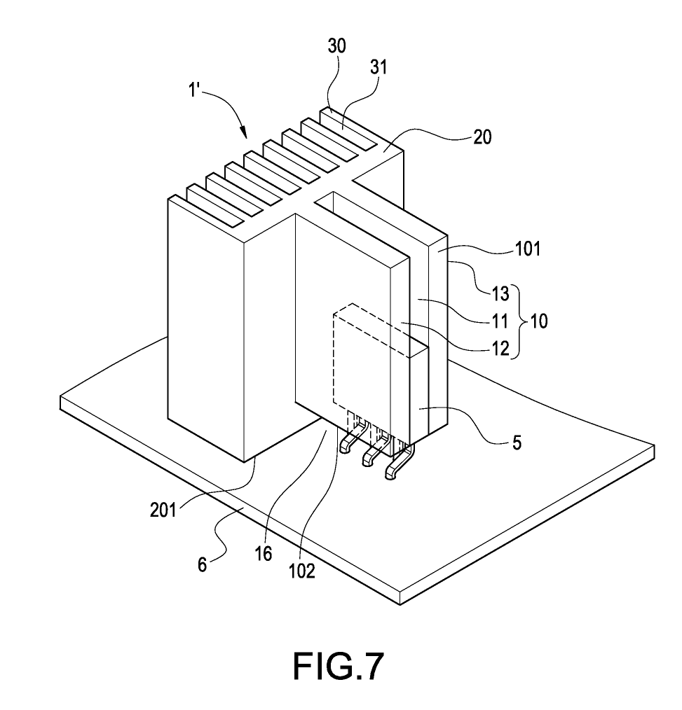

Please refer to FIG. 6 and FIG. 7, which show a bidirectional heat sink 1′ according to another embodiment of the present disclosure. The separation walls 12, 13 of the first heat-dissipating plate 10 have a first surface 102 perpendicular to the bottom surface 101. The second heat-dissipating plate 20 has a second surface 201 in parallel to the first surface 102. The height of the first surface 102 is different from that of the second surface 201, so that a stepped portion 16 is formed between the first surface 102 of the first heat-dissipating plate 10 and the second surface 201 of the second heat-dissipating plate 20. When the bidirectional heat sink 1′ is disposed on the package element 5, the second surface 201 of the second heat-dissipating plate 20 can be adhered onto the circuit board 6 as shown in FIG. 7, thereby forming a firm structure.

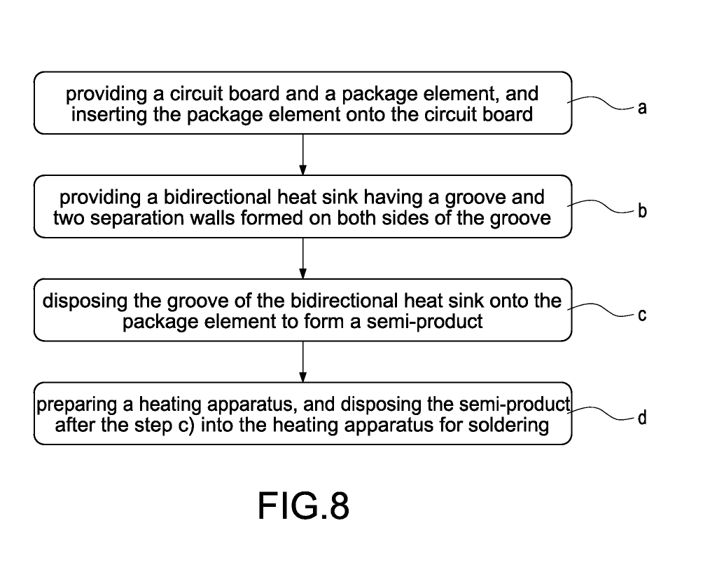

Please refer to FIG. 8, which shows a method for assembling a bidirectional heat sink of the present disclosure and a package element. The inventive method includes steps of:

a) providing a circuit board 6 and a package element 5, and inserting the package element 5 onto the circuit board 6;

b) providing a bidirectional heat sink 1 having a groove 11 and two separation walls 12, 13 formed on both sides of the groove 11;

c) disposing the groove 11 of the bidirectional heat sink 1 onto the package element 5 to form a semi-product; and

d) preparing a heating apparatus, and disposing the semi-product after the step c) into the heating apparatus for soldering.

Further, after the step a) or b), the inventive method has a step of applying a heat-conducting medium 40 on the surfaces of the package element 5.

In the bidirectional heat sink of the present disclosure, two surfaces of the heat sink are brought into thermal contact with the package element for heat conduction. Without clips and screws, the package element is inserted into the circuit board and then the heat sink is disposed onto the circuit board to thermally contact and fix the package element. Thus, the method of the present disclosure is a novel assembling method for generating a heat sink of high heat-dissipating efficiency.

In comparison with prior art, the present inventive method improves the quality control during the producing process, increases the heat-dissipating efficiency, and reduces the material cost and labor hours.

(1) According to the present inventive method, it is unnecessary to use clips and screws during the assembly. Thus, the possible damage package element caused by external forces can be reduced to improve the quality of final products. In this way, the lifetime of the package element can be assured.

(2) Both surfaces of the package element are brought into thermal contact with the heat sink, thereby generating heat conduction in dual directions for an optimal heat-dissipating effect. In this way, the high performance package element can be kept in a normal working environment, thereby increasing the quality and stability of the final products having such a package element.

(3) According to the present inventive method, since it is unnecessary to use the clips and screws for assembling the package element, the material cost is reduced. Further, by the present inventive method, a plurality of transistors and package elements can be inserted onto the printed circuit board together with the heat sink, thereby reducing the number of pins and simplifying the assembling process.

Although the present disclosure has been described with reference to the foregoing preferred embodiments, it will be understood that the disclosure is not limited to the details thereof. Various equivalent variations and modifications can still occur to those skilled in this art in view of the teachings of the present disclosure. Thus, all such variations and equivalent modifications are also embraced within the scope of the disclosure as defined in the appended claims.

What is claimed is:

1. A bidirectional heat sink (1) for a package element (5), including:
a first heat-dissipating plate (10) provided with a groove (11), both sides of the groove (11) being formed with two separation walls (12, 13), the package element (5) being inserted into the groove (11) to contact the two separation walls (12, 13);
a second heat-dissipating plate (20) extending from one end of the first heat-dissipating plate (10); and
a plurality of heat-dissipating pieces (30) extending from the second heat-dissipating plate (20) in a direction away from the first heat-dissipating plate (10).

2. The bidirectional heat sink for a package element according to claim 1, wherein the bidirectional heat sink (1) is a metallic component made of aluminum, copper or alloys thereof.

3. The bidirectional heat sink for a package element according to claim 1, wherein the first heat-dissipating plate (10), the second heat-dissipating plate (20) and the heat-dissipating pieces (30) are integrally formed.

4. The bidirectional heat sink for a package element according to claim 1, wherein the first heat-dissipating plate (10) and the second heat-dissipating plate (20) are perpendicular to each other to form a T-shaped structure.

5. The bidirectional heat sink for a package element according to claim 4, wherein one end of each separation wall (12, 13) is provided with a notch (14) away from the second heat-dissipating plate (20), and the notch (14) is located to correspond to the package element (5).

6. The bidirectional heat sink for a package element according to claim 1, wherein the heat-dissipating pieces (30) are arranged at intervals and in parallel to each other, and a heat-dissipating channel (31) is formed between any two adjacent heat-dissipating pieces (30).

7. The bidirectional heat sink for a package element according to claim 1, further including a heat-conducting medium (40) filled between surfaces of the separation walls (12, 13) and the package element (5).

8. The bidirectional heat sink for a package element according to claim 1, wherein the first heat-dissipating plate (10) has a bottom surface (101), each of the separation walls (12, 13) of the first heat-dissipating plate (10) has a first surface (102) perpendicular to the bottom surface (101), the second heat-dissipating plate (20) has a second surface (201) in parallel to the first surface (102), and the height of the first surface (102) is different from that of the second surface (201), thereby forming a stepped portion (16) between the first surface (102) of the first heat-dissipating plate (10) and the second surface (201) of the second heat-dissipating plate (20).

9. A method for assembling a package element and a bidirectional heat sink, including steps of:
a) providing a circuit board (6) and a package element (5), and inserting the package element (5) onto the circuit board (6);
b) providing a bidirectional heat sink (1) having a groove (11) and two separation walls (12, 13) formed on both sides of the groove (11);
c) disposing the groove (11) of the bidirectional heat sink (1) onto the package element (5) to form a semi-product; and
d) preparing a heating apparatus, and disposing the semi-product after the step c) into the heating apparatus for soldering.

10. The method according to claim 9, further including a step of applying a heat-conducting medium (40) to surfaces of the package element (5) after the step a) or the step b).
